(19) United States
(12) Patent Application Publication
(10) Pub. No.: US 2003/0026101 A1
(43) Pub. Date: Feb. 6, 2003

(54) Pathway reflector

(76) Inventor: Suzanne R. Antonowitsch, Montrose, CO (US)

Correspondence Address: MORLAND C FISCHER, 2030 MAIN ST, SUITE 1050, IRVINE, CA, 92614

(21) Appl. No.: 09/921,093

(22) Filed: Aug. 3, 2001

(51) Int. Cl. F21V 7/00

(52) U.S. Cl. 362/341

(57) ABSTRACT

A low cost, easy to assemble pathway reflector having a hollow, spherical light reflector element coupled to a support pole that is capable of being staked in the ground at any convenient location, such as at the entrance to driveway, along a walkway, or around an area at which caution is to be exercised, so as to reflect light from oncoming headlights, a flashlight, or even the moon to alert motorists and passersby to an upcoming feature, building or site in the landscape. The spherical reflector element has a light reflecting surface which may be a coating, paint or reflective tape. According to a first embodiment, the support pole has a threaded end which is pushed through the spherical reflector element to be detachably connected to a screw threaded end cap whereby to prevent a removal of the reflector element from the support pole. According to a second embodiment, the support pole is pushed axially through the spherical reflector element to be connected to an end cap to establish an axle around which the reflector element is adapted to rotate in the wind.

### BACKGROUND OF THE INVENTION

1. Field of the Invention

This invention relates to a low cost, easy to assemble pathway reflector having a spherical reflector element coupled to a support pole that is capable of being staked at any convenient location (e.g. at the entrance to a driveway, along a walkway, or around an area at which caution is to be exercised) so as to reflect light from oncoming headlights, a flashlight, or even the moon to alert motorists and passersby to an upcoming feature, building or site in the landscape.

2. Background Art

Electric lighting is commonly used to mark the entrance to a driveway, a roadway, a walkway, and the like. In this case, a source of power (either AC or battery voltage) must be supplied to the electric lighting which increases the complexity and cost of the lighting system, especially when electrical wiring is connected from light-to-light. It is not always a simple task to remove or relocate an electrical lighting system once it has been installed at a particular site.

Moreover, there may be cases when it is not convenient or practical to use electric lighting to mark a remote or distant site or to indicate the location of an obstacle or hazard which should be avoided. For example, an area to be lighted may be too far from a source of AC power to justify running electrical wires to the lights. It may be that the need to light a small area (e.g. a pile of rocks, a hole in the ground, broken pavement, etc.) is only temporary or that the lights must be frequently removed. These situations will discourage the installation of permanent or expansive lighting systems. Finally, so as to conserve energy, it may not be desirable to have a lighting system operating continuously when it is only necessary to illuminate a relatively small area on an infrequent basis.

Therefore, what is needed is a low cost, easy to assemble and easy to remove light reflecting system that can be conveniently positioned and repositioned near a driveway, walkway or hazard, does not require or consume electrical power, and is readily visible to the operators of motor vehicles and passersby on an as-needed basis.

### SUMMARY OF THE INVENTION

A low cost, easy to assemble and easy to install pathway reflector is disclosed which requires no electrical wires or power to operate and which can be quickly removed for storage or relocation. One or more of my pathway reflectors can be advantageously located at the entrance to a driveway, along a walkway, or near a hazard to be avoided. My reflector is adapted to reflect light from ongoing headlights, a flashlight, and even moonlight so as to alert motorists and passersby to an upcoming feature, building or site in the landscape.

My pathway reflector includes a spherical reflector element that is preferably manufactured from plastic. A plurality of slits are spaced around the reflector element to form air passages and thereby minimize resistance to gusts of wind. A round hole is formed through each of the top and bottom of the spherical reflector element in axial alignment with one another. As an important detail, the reflector element is covered with a light reflecting paint, coating or tape.

In a first case, the spherical reflector element is detachably connected to a flexible support pole that is manufactured from metal and has a cylindrical sleeve extending therearound. The top end of the support pole is threaded, and the bottom end of the pole has at a point so as to facilitate the support pole being staked in the ground. In the assembled relationship, the support pole is pushed upwardly through the hole at the bottom of the spherical reflector element such that the cylindrical sleeve carried by the support pole is located under the reflector element and the threaded top end of the pole projects outwardly from the hole at the top of the reflector element. A threaded end cap is then mated to the threaded top end of the support pole to hold the spherical reflector element on the pole.

In the case where the support pole is manufactured from a non-metallic material, the spherical reflector element is coupled to the support pole between an end cap and a disk-shaped base. The support pole is pushed upwardly through and outwardly from the reflector element until the base cradles the bottom of the reflector element. The end cap is then attached to the outwardly projecting end of the support pole, whereby the support pole functions as an axle and the reflector element is adapted to spin around the pole in windy conditions.

### BRIEF DESCRIPTION OF THE DRAWINGS

FIG. 1 shows a pair of my pathway reflectors staked in the ground adjacent the entrance to a driveway;

FIG. 2 shows my pathway reflector of FIG. 1 in the assembled configuration;

FIG. 3 is an exploded view showing my pathway reflector in the disassembled configuration;

FIG. 4 is a cross-section taken along lines 4-4 of FIG. 2; and

FIG. 5 shows my pathway reflector according to an alternate embodiment of this invention.

### DETAILED DESCRIPTION

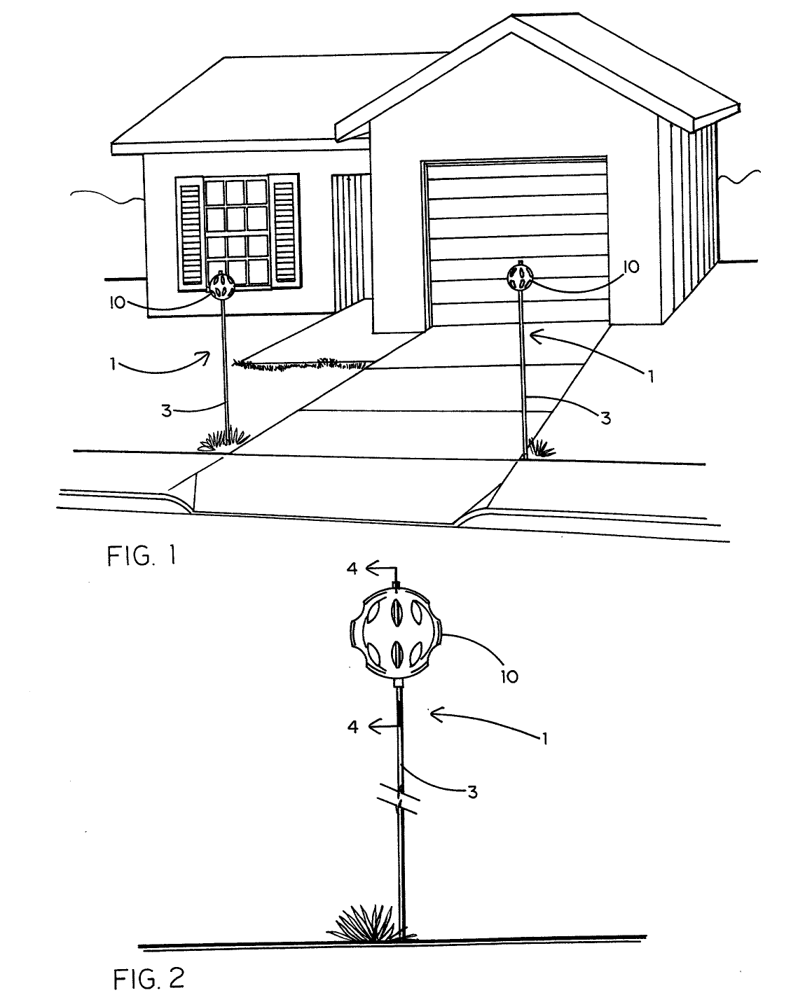

Details of the low cost, easy to assemble and easy to remove pathway reflector which forms a first embodiment of my invention are described while initially referring to FIGS. 1-4 of the drawings, where FIG. 1 shows a pair of my reflectors 1 positioned adjacent the entrance to a driveway, such as that which leads to a house or a garage. However, my reflector 1 can be positioned near any feature, building or site in the landscape (e.g. at a roadway or walkway) to help mark a path for pedestrians, joggers, drivers and passersby. Moreover, any number of reflectors 1 can be used to mark the path. That is to say, a pair of my reflectors 1 can be positioned on opposite sides of the entrance to a driveway (as shown) or spaced at suitable distances from one another along both sides of a path, especially if the path is long and/or winding. My reflector 1 is particularly useful where it is not convenient or practical to have electric lights to mark the entrance to or direction of a pathway.

My pathway reflector 1 includes a support pole 3. The support pole 3 is preferably flexible so as to bend slightly in the wind. By way of example, the support pole 3 is manufactured from metal or fiberglass, although the precise material from which the support pole is made is not to be considered a limitation of my invention. The support pole 3 preferably has a diameter of 1/4 inch and stands about 3½ feet high so that a reflector element 10 to be coupled to the support pole will be easily visible to drivers and passersby. The bottom of the support pole 3 has a relatively sharp point to enable the pole to be easily staked in the ground adjacent a driveway, walkway, and even around a potentially hazardous obstacle to be noticed and avoided. According to the first embodiment, the support pole 3 is manufactured from metal. In this case, a screw threaded portion 5 is formed at the top end of the pole 3. The function of the threaded top end 5 for coupling the reflector element 10 to the support pole 3 will soon be described. A cylindrical sleeve 16 surrounds the support pole 3 below the threaded top end 5 thereof

The reflector element 10 of my pathway reflector 1 is illustrated in FIGS. 1-4 of the drawings as having a spherical shape and being coupled to the support pole 3. It has been found that a spherical reflector element 10 having a diameter of about 2½ inches is suitable to achieve the advantages to be described herein. To minimize weight, the spherical reflector element 10 is manufactured from plastic. To further minimize weight, the spherical reflector element 10 is hollow. A plurality of air flow slits 12 are spaced around the reflector element 10 to reduce the effects of the wind by establishing entrance and exit openings through which gusts of wind can flow without toppling the flexible support pole 3 or blowing away the reflector element 10 that is coupled thereto.

A round hole 14 (best shown in FIG. 3) is formed through the top of the spherical reflector element 10 and sized to receive the threaded end 5 of support pole 3. Another round hole 15 which is axially aligned with the hole 14 is formed through the bottom of the spherical reflector element 10 and also sized to receive the threaded end 5 of support pole 3.

As an important detail of my pathway reflector 1, the spherical reflector element 10 has a light reflecting surface 18. Light reflecting surface 18 may be a coating or paint that is applied to the reflector element 10 by means of a paint brush. In the alternative, the light reflecting surface 18 may be a reflective tape that is adhesively bonded to the reflector element 10.

Depending upon the site at which one or more support poles 3 are staked in the ground, the headlights from an oncoming motor vehicle about to enter a driveway (as shown in FIG. 1) or a beam of light from a flashlight carried by a passerby along a walkway, and even the moon's light will be reflected from the reflecting surface 18 over the reflector element 10 of my pathway reflector 1. Accordingly, a motorist or passerby will be quickly and easily alerted to the location of a driveway or walkway to follow or an obstacle to avoid or exercise caution.

To complete the installation of my pathway reflector 1, the reflector element 10 is mounted on the support pole 3 by first pushing the threaded top end 5 thereof upwardly through the hole 15 at the bottom of the reflector element 10. Next, the threaded end 5 is pushed completely through the hollow interior of the reflector element 10 and outwardly of the axially aligned hole 14 at the top of the reflector element such that the reflector element is resting atop the cylindrical sleeve 16. In the first case, where the support pole 3 is manufactured from metal with the threaded top end 5 projecting outwardly through hole 14 to lie above the spherical reflector element 10, a threaded end cap 20 is mated to the threaded end 5 whereby to detachably connect the spherical reflector element 10 to the support pole 3 to complete the pathway reflector 1 and thereby prevent the reflector element 10 from being blown or pulled off the pole. The cylindrical sleeve 16 carried by the support pole 3 and located under the spherical reflector element 10 will prevent the reflector element from sliding down the support pole 3 under the influence of gravity.

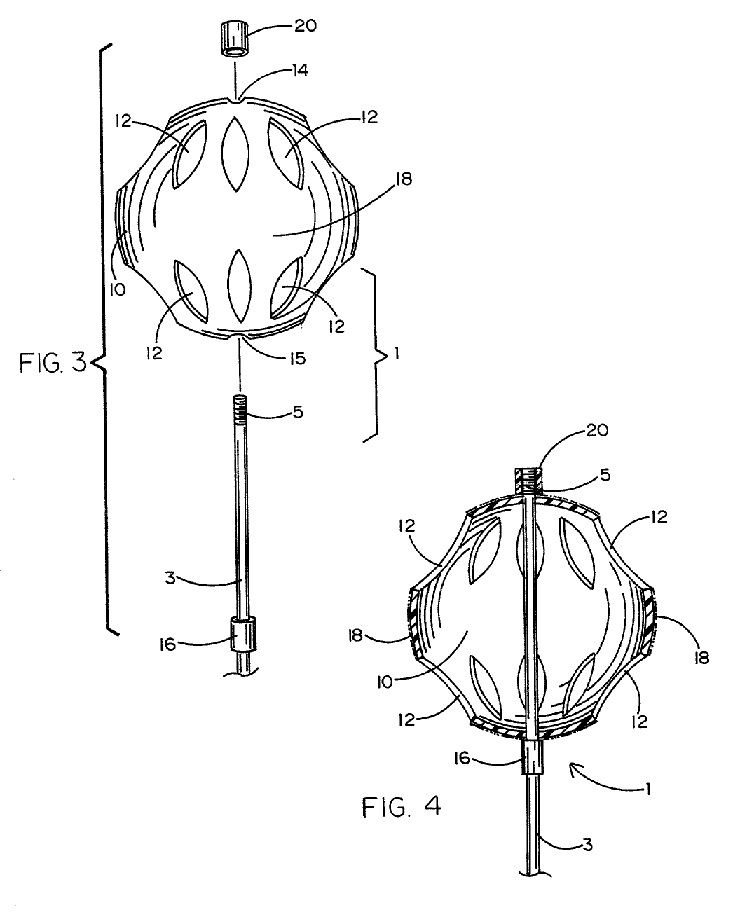

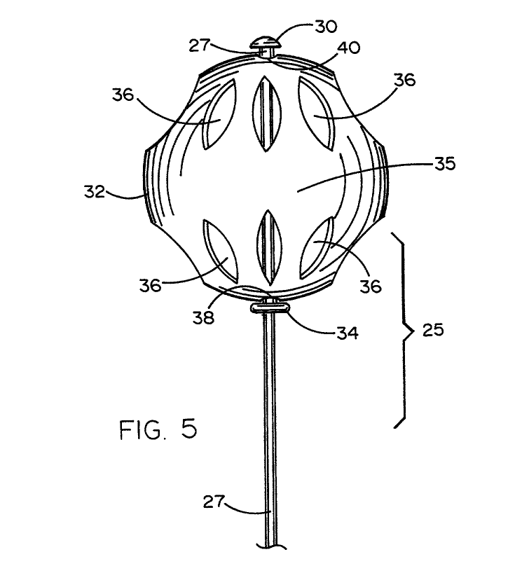

FIG. 5 of the drawings shows an alternate embodiment of my pathway reflector 25 in the case where the support pole 27 is manufactured from a non-metallic (e.g. fiberglass) material, such that it is not feasible to form the threaded top end (designated 5 in FIGS. 3 and 4). In this embodiment, an end cap 30 will be attached to the top of the support pole 27 to prevent the removal of a hollow, spherical reflector element 32 therefrom. A disk-shaped seat 34 surrounds the support pole 27 so as to receive the reflector element 32 resting thereupon. The end cap 30 and the disk-shaped seat 34 are manufactured from either metal or plastic and attached to the support pole 27 above and below the reflector element 32. Reflector element 32 has the same light reflecting surface 35 and air flow slits 36 that are also part of the reflector element 10 of FIGS. 1-4.

To complete the assembly of my pathway reflector 25 as shown in FIG. 5, the spherical reflector element 32 is coupled to an unthreaded support pole 27 by first pushing the top of the pole upwardly through a hole 38 at the bottom of the reflector element 32 until the reflector element rests upon the seat 34. The support pole extends completely through the hollow interior of the reflector element 32 so as to project outwardly from the top of the reflector element via a hole 40. The end cap 30 is then affixed (e.g. glued) to the top of the support pole 27.

It may be appreciated that the support pole 27 running axially through the spherical reflector element 32 functions as an axle, and the oppositely disposed end cap 30 and seat 34 carried by support pole 27 function as bearings so that the reflector element 32 located therebetween can spin freely around the support pole 27 in response to a windy condition. This may enhance the visibility of the reflector element 32 depending upon the nature of light reflecting surface 35 thereof

As indicated above, any number of my pathway reflectors 1 or 25 can be easily and quickly assembled and staked in the ground at the entrance to a driveway or along a walkway or around an area at which caution should be exercised. Because of the spherical shape of the reflector elements 10 and 32, the operator of a motor vehicle or a passerby with a flashlight will be able to visibly detect the reflected light and take appropriate notice or action. Of course, my pathway reflectors 1 or 25 can also be quickly and easily removed from the ground and disassembled for storage or relocation from place-to-place on an as-needed basis without altering the landscape or having to be disconnected from an electrical power source.

I claim:

1. A light reflecting marker to indicate the location of a feature, structure or site in the landscape, said light reflecting marker comprising:
a support pole having first and second ends, the first end of said support pole adapted to be staked in the ground and the second end of the support pole being screw threaded;
a reflector element having a body and a light reflecting surface on said body;
said support pole being pushed through the body of said reflector element such that the screw threaded end of said support pole projects outwardly from said body; and
a screw threaded fastener to be mated to the screw threaded end of said support pole to prevent the removal of said reflector element from said support pole.

2. The light reflecting marker recited in claim 1, wherein said support pole has a cylindrical sleeve extending therearound below said screw threaded end, said reflector element resting upon said cylindrical sleeve when said support pole is pushed through the body of said reflector element.

3. The light reflecting marker recited in claim 2, wherein said support pole extends axially through the body of said reflector element between said cylindrical sleeve and said screw threaded fastener.

4. The light reflecting marker recited in claim 1, wherein the body of said reflector element has a spherical shape.

5. The light reflecting marker recited in claim 1, wherein the body of said reflector element is hollow.

6. The light reflecting marker recited in claim 5, wherein the body of said reflector element has a plurality of air passages formed therein by which the wind can flow through said body.

7. A light reflecting marker to indicate the location of a feature, structure or site in the landscape, said light reflecting marker comprising:
a support pole having first and second ends, the first end of said support pole adapted to be staked in the ground;
a reflector element having a body and a light reflecting surface on said body;
said support pole being pushed through the body of said reflector element such that the second end of said support pole projects outwardly from said reflector element and said reflector element is adapted to rotate around said support pole; and
an end cap attached to the second end of said support pole projecting outwardly from said reflector element.

8. The light reflecting marker recited in claim 7, wherein said support pole has a seat connected thereto below said second end, said reflector element resting upon said seat when said support pole is pushed through the body of said reflector element, whereby said support pole forms an axle extending between said seat and said end cap around which said reflector element is adapted to rotate.

9. The light reflecting marker recited in claim 7, wherein the body of said reflector element is a hollow sphere.

10. The light reflecting marker recited in claim 9, wherein the body of said reflector element has a plurality of air passages formed therein by which the wind can flow through said body.
